(19) United States
(12) Patent Application Publication
(10) Pub. No.: US 2011/0009577 A1
(43) Pub. Date: Jan. 13, 2011

(54) ENHANCED CONDENSED MODE OPERATION IN METHOD OF PRODUCING POLYOFEFINS WITH CHROMIUM BASED CATALYSTS

(75) Inventor: Robert J. Jorgensen, Scott Depot, WV (US)

Correspondence Address: THE DOW CHEMICAL COMPANY;BAKER & MCKENZIE LLP, PENNZOIL PLACE, SOUTH TOWER, 711 LOUISIANA, SUITE 3400, HOUSTON, TX, 77002-2716, US

(73) Assignee: Union Carbide Chemicals & Plastics Technology LLC, Midland, MI (US)

(21) Appl. No.: 12/833,768

(22) Filed: Jul. 9, 2010

Related U.S. Application Data
(60) Provisional application No. 61/224,415, filed on Jul. 9, 2009.

(51) Int. Cl. C08F 4/622

(52) U.S. Cl. 526/105; 526/169; 526/127; 502/152

(57) ABSTRACT

A gas phase polymerization process for producing a polyethylene polymer including polymerizing ethylene and optionally at least one α-olefin comonomer in a fluidized bed reactor under condensed mode operating conditions using a Cr⁺⁶-based supported catalyst and a catalyst initiation enhancing agent is provided. The catalyst initiation enhancing agent is an aluminum alkyl solution that is present in the fluidized bed reactor at effective Al/Cr ratios between 0.2 to 1.5. A catalyst initiation enhancing system including at least one aluminum alkyl and at least one hydrocarbon solvent wherein the aluminum alkyl is present in the solvent at concentrations of less than about 0.03 molar.

### CROSS REFERENCE TO RELATED APPLICATIONS

This application claims priority to U.S. Provisional Application No. 61/224415, filed Jul. 9, 2009.

### FIELD OF INVENTION

The instant invention relates to a gas phase process of producing polyethylene compositions with enhanced condensed mode operation in the presence of Cr⁺⁶-based catalysts, polyethylene polymer composition produced by such process and a catalyst initiation enhancing system for use in connection with the process.

### BACKGROUND OF THE INVENTION

Gas phase polymerization of ethylene or copolymerization of ethylene and at least one other α-olefin in the presence of a chromium-based catalyst on a support (i.e., a Phillips-type catalyst) is known. Likewise, condensed mode operation of gas phase polymerization is well known in systems and methods utilizing other types of catalysts, including Ziegler-Natta and metallocene catalysts. Condensed mode operation results when higher production rates are employed to increase production. Use of Cr⁺⁶-based catalysts in condensed mode operation of gas phase polymerizations are much less successful.

First, supported chromium based catalysts exhibit a number of operational problems in the condensed mode, including expanded section sheeting, increased plate pluggage and unwanted polymer deposition. More particularly, it is believed that catalyst rich fine particulates migrate to stagnant areas or areas with decreased flow of the reactor system, including below the distributor plate, the expanded section, expanded section dome, transition pieces, and the like. Active catalyst particulates in contact with condensate in such stagnant or low flow areas continue to induce polymerization. Moreover, the lower condensate temperature results in a higher molecular weight of the polymer formed in the stagnant or low flow areas, giving rise to gel formation concerns. In addition, continuous gas phase polymerization systems typically include a recycle system for removal and/or control of heat. Such recycle systems are generally prone to fouling, sheeting and/or static generation. Such fouling may be of particular concern where catalyst fines are entrained in the recycle stream.

Additionally, because comonomer incorporation with such catalysts is high, there may be insufficient comonomer content in the reactor gas to serve as a condensing agent. Thus, additional compounds must be added to increase the cycle gas dew point, that is, to induce condensation. In practice, hexane and isopentane have been used as induced condensing agents. The commodity nature of such additives, however, may introduce varying levels of impurities into the process resulting in uneven operation and process upsets.

Another concern with the use of chromium based catalysts in gas phase polyethylene production arises from the fact that resultant polymer properties may be affected by reactor residence time. One of the goals of condensed mode operation is to increase the production rate, with a consequential reduction in residence time, without changing the resultant polymer properties.

U.S. Pat. No. 6,891,001 discloses a chromium oxide catalyst supported on a granular or microspherical refractory oxide in a fluidized bed reactor having a recycle gas line, under polymerization conditions, characterized in that: (1) oxygen is introduced into the reactor in the range of 0.03 to 1 ppm by volume to ethylene; (2) an organoaluminum compound is introduced into the reactor in the range of 0.0001 to 0.05 mole per ton of ethylene; and (3) the polymerization is carried out at a temperature in the range of 80 to 120° C.

U.S. Pat. No. 6,875,835 discloses the use of an activated chromium containing catalyst system and a co-catalyst selected from the group consisting of trialkylboron, trialkylsiloxyaluminum, and a combination of trialkylboron and trialkylaluminum compounds.

U.S. Pat. No. 6,828,268 discloses co-catalysts selected from the group consisting of (i) alkyllithium compounds; (ii) dialkylaluminum alkoxides in combination with at least one metal alkyl selected from the group consisting of alkylzinc compounds, alkylaluminum compounds, alkylboron compounds, and mixtures thereof; and (iii) mixtures thereof in order to decrease the melt flow characteristics of the resultant polymer. Trialkylaluminum compounds are not used alone but rather must be used in combination with either an aluminum alkoxide or alkyllithium compound as taught in this patent. Moreover, condensed mode gas phase reaction is not taught by the patent.

U.S. Pat. No. 5,075,395 discloses the use of aluminum alkyl co-feed in a start-up period (but for less than 24 hours) of a polymerization of ethylene or copolymerization of ethylene using a chromium oxide based catalyst. The steady state Al concentration is about 0.4-0.5×10⁻⁶ moles/gm (0.44 moles/ton). This reference does not teach condensed mode operation nor continuous (following start up) feed of the aluminum alkyl compound.

Therefore, there is still a need for a gas phase polymerization of ethylene or copolymerization of ethylene and at least one other α-olefin that may be operated at high rates and condensed mode to achieve higher production rates while not changing the character of the polymer produced and without increased operational problems associated with undesirable fouling, sheeting or gel formation.

### SUMMARY OF THE INVENTION

Some embodiments of the invention provide a gas phase polymerization process for producing a polyethylene polymer including polymerizing ethylene and optionally at least one α-olefin comonomer in a fluidized bed reactor under condensed mode operating conditions using a Cr⁺⁶-based supported catalyst and a catalyst initiation enhancing agent comprising an aluminum alkyl. In certain embodiments of the invention the aluminum alkyl is selected from the group consisting of compound having the general formula R₃Al wherein R can be any alkyl group having between two and six carbons and wherein the R groups can be the same or different. In specific embodiments the aluminum alkyl is triethylaluminum, tripropylaluminum, tri-isobutylaluminum, tripentylaluminum, and/or tri-n-hexylaluminum. Alpha-olefin comonomers useful in embodiments of the invention include α-olefins having twenty or fewer carbon atoms and more specifically, include propylene, 1-butene, 1-hexene, and 1-octene. Embodiments of the invention include use of Cr⁺⁶-based supported catalyst including chromium oxide supported on silica and (bis-triphenylsilyl)chromate supported on silica.

In some embodiments of the invention, the aluminum alkyl is dissolved in a solvent, including induced condensing agents, comonomers, and/or a hydrocarbon that is unreactive with the Cr⁺6-based supported catalyst. In certain embodiments, the solvent is isopentane, butane, hexane, hexene, or combinations thereof. The concentration of aluminum alkyl in the solvent is generally between 0.03 molar and 0.0001.

In certain embodiments of the inventive process, the aluminum alkyl solution is injected into the fluidized bed reactor at a location between one-eighth and one-half the height of the fluidized bed. In some embodiments, the concentration of the aluminum alkyl in the fluidized bed reactor is between 0.003 micromoles/g and 0.010 micromoles/g and the fluidized bed has an effective Al/Cr molar ratio of between 0.2 and 1.5.

Chromium oxide supported on silica may be used in certain embodiments of the invention. In such embodiments, the fluidized bed may have an effective Al/Cr molar ratio of between 0.4 and 1.5. In yet other embodiments of the invention, the catalyst may be (bis-triphenylsilyl)chromate supported on silica.

Yet other embodiments provide a polyethylene polymer produced via the inventive gas phase polymerization processes.

Yet additional embodiments of the invention provide a catalyst initiation enhancing system for use in a fluidized bed polymerization reactor operating in condensed mode, the system including at least one aluminum alkyl; at least one hydrocarbon solvent, wherein the aluminum alkyl is present in the solvent at concentrations of less than about 0.03 molar. In such embodiments, the solvent is butane, isopentane, hexane, hexene, and/or combinations thereof.

### DETAILED DESCRIPTION OF THE INVENTION

The instant invention is a process of polymerizing ethylene or copolymerizing ethylene and at least one other α-olefin, a system utilizing such method, and polymers produced therefrom. The invention also relates to a polymerization process having improved operability and polymer characteristic uniformity. It has been surprisingly discovered that a gas phase polymerization process of ethylene or copolymerization of ethylene and at least one other alpha-olefin utilizing a chromium based catalyst operating in condensed mode may be substantially improved by the use of a catalyst initiation enhancing agent. Use of the catalyst initiation enhancing agent prevents operating problems while maintaining polymer characteristic and further while maintaining commercially desirable production rates.

The term (co)polymerization, as used herein, refers to the polymerization of ethylene and optionally one or more comonomers, e.g. one or more α-olefin comonomers. Thus, the term (co)polymerization refers to both polymerization of ethylene and copolymerization of ethylene and one or more comonomers, e.g. one or more α-olefin comonomers.

The α-olefin comonomers typically have no more than 20 carbon atoms. For example, the α-olefin comonomers may preferably have 3 to 10 carbon atoms, and more preferably 3 to 8 carbon atoms. Exemplary α-olefin comonomers include, but are not limited to, propylene, 1-butene, 1-pentene, 1-hexene, 1-heptene, 1-octene, 1-nonene, 1-decene, and 4-methyl-1-pentene. The one or more α-olefin comonomers may, for example, be selected from the group consisting of propylene, 1-butene, 1-hexene, and 1-octene; or in the alternative, from the group consisting of 1-hexene and 1-octene.

In the inventive process, a Cr⁺⁶-based catalyst system, a catalyst initiation enhancing agent, as described herein below in further details, ethylene, optionally one or more α-olefin comonomers, hydrogen, optionally one or more inert gases and/or liquids, e.g. N₂, isopentane, and hexane], are continuously fed into a reactor, e.g. a fluidized bed gas phase reactor

The reactor may be in fluid communication with one or more discharge tanks, surge tanks, purge tanks, and/or recycle compressors. The temperature in the reactor is typically in the range of 70 to 115° C., preferably 75 to 110° C., more preferably 80 to 105° C., and the pressure is in the range of 15 to 30 atm, preferably 17 to 26 atm. A distributor plate at the bottom of the polymer bed provides a uniform flow of the upflowing monomer, comonomer, and inert gases stream. A mechanical agitator may also be provided to provide contact between the solid particles and the comonomer gas stream. The fluidized bed, a vertical cylindrical reactor, may have a bulb shape at the top to facilitate the reduction of gas velocity; thus, permitting the granular polymer to separate from the upflowing gases. The unreacted gases are then cooled to remove the heat of polymerization, recompressed, and then recycled to the bottom of the reactor. Once the residual hydrocarbons are removed, and the resin is transported under N₂ to a purge bin, moisture may be introduced to reduce the presence of any residual catalyzed reactions with O₂ before the polymer composition is exposed to oxygen. The polymer composition may then be transferred to an extruder to be pelletized. Such pelletization techniques are generally known.

The polymer composition may further be melt screened. Subsequent to the melting process in the extruder, the molten composition is passed through one or more active screens, positioned in series of more than one, with each active screen having a micron retention size of from 2 μm to 400 μm (2 to 4×10⁻⁵ m), and preferably 2 μm to 300 μm (2 to 3×10⁻⁵ m), and most preferably 2 μm to 70 μm (2 to 7×10⁻⁶ m), at a mass flux of 5 to 100 lb/hr/in² (1.0 to 20 kg/s/m²). Such further melt screening is disclosed in U.S. Pat. No. 6,485,662, which is incorporated herein by reference to the extent that it discloses melt screening.

The catalyst used in the invention may be either of two classes of Cr⁺⁶-based catalysts. The first such class of catalysts includes chromate esters, including without limitation, (bis-triphenylsilyl)chromate supported on a refractory oxide or other inorganic oxide granular or microspherical support, including without limitation, supports such as silica, silica-alumina, thoria, zirconia, and the like. These chromate ester catalysts are prepared by contacting the chromate ester in a hydrocarbon slurry with the support material. The contact time ranges between less than 1 hour to as high as 24 hours. The support material is typically thermally treated to produce a more uniform support surface. Without being bound by any particular theory, it is believed that the chromate ester chemically adsorbs on the support through reaction with surface hydroxyl groups on the support. An especially preferred chromate ester is (bis-triphenylsilyl)chromate. Once deposited on the support substrate, the material may either be dried and used as is or alternately contacted with small amounts of an aluminum alkyl, up to an Al/Cr mole ratio of about 1.5, then dried before use. If contacted with aluminum alkyl, an especially preferred alkyl is diethylaluminumethoxide.

The second class of catalysts are based on CrO₃ or chromium compounds oxidizable to Cr⁺⁶, i.e., chromium oxide, supported on a refractory oxide or other inorganic oxide granular or microspherical support, including without limitation, supports such as silica, silica-alumina, thoria, zirconia, and the like. Non-limiting examples of Cr⁺⁶-based catalysts suitable for use herein are disclosed in U.S. Pat. Nos. 3,709,853; 3,709,954; and 4,077,904; and 6,982,304, the disclosures of which are incorporated herein by reference in their entirety.

Examples of chromium oxide catalysts according to the present invention are typically those comprising a refractory oxide support which is activated by a heat treatment advantageously carried out at a temperature of at least 250° C. and at most equal to the temperature at which the granular support begins to sinter and under a non-reducing atmosphere and preferably an oxidizing atmosphere. This catalyst can be obtained by a great number of known process, in particular by those according to which, in a first stage, a chromium compound, such as a chromium oxide, generally of formula CrO₃, or a chromium compound which can be converted by calcination into chromium oxide, such as, for example, a chromium nitrate or sulphate, an ammonium chromate, a chromium carbonate, acetate or acetylacetonate, or a tert-butyl chromate, is combined with a granular support based on refractory oxide, such as, for example, silica, alumina, zirconium oxide, titanium oxide or a mixture of these oxides or aluminum or boron phosphates or mixtures in any proportion of these phosphates with the above mentioned oxides. The support for the chromium based catalyst may be optionally treated with surface modifying compounds such as titanate esters. The support may be treated with the titanate ester either before deposition of the chromium compound, after the deposition of the chromium compound or during the actual calcination. Preferred titanate esters are tetraethyltitanate and tetraisopropyltitanate. A preferred method of addition of the surface modifier is by addition in a hydrocarbon slurry, followed by solvent removal and subsequent calcination. In a second stage, the chromium compound thus combined with the granular support is subjected to conversion to an active Cr⁺⁶ valence state, by heat treatment in a non-reducing atmosphere and preferably an oxidizing atmosphere at a temperature of at least about 250° C. and at most that at which the granular support begins to sinter. The temperature of the heat treatment is generally between 250° C. and 1200° C. and most preferably between 350 and 1000° C.

Chromium oxide based catalysts are strongly affected by impurities such as oxygen and moisture. Polymer properties also depend on the residence time of the catalyst in the reactor. Without being bound by any particular theory, it is believed that the kinetics of chromium oxide based catalysts can be summarized in the following manner in the absence of the catalyst initiation enhancing agent utilized in the invention:

CrO₃+C₂H₄→Cr⁺²+2CH₂O, k_{reduction} (1)

CH₂O diffusion, k_{diffusion} (2)

Cr⁺²+C₂H₄→Cr(C₂H₄), kᵢₙᵢₜᵢₐₜᵢₒₙ (3)

Cr(C₂H₄)+n(C₂H₄)→Cr—(CH₂CH₂)ₙ˜k_{propagation} (4)

Cr—CH₂CH₂˜+RCH═CH₂→Cr—CH₂CH₂—R+CH₂—C˜kₜₑᵣₘᵢₙₐₜᵢₒₙ (5)

where k_{reduction} is the reduction rate constant, k_{diffusion} is the activation or diffusion rate constant, kᵢₙᵢₜᵢₐₜᵢₒₙ is the initiation rate constant k_{propagation} is the propagation rate constant and kₜₑᵣₘᵢₙₐₜᵢₒₙ is the termination rate constant. As can be seen in equations (1)-(2), there are two rate limiting steps prior to commencement of polymerization. First, the active site must be created through the reduction of the Cr⁺⁶ to Cr⁺². Active site creation occurs through oxidation of the ethylene or alpha-olefin comonomer thereby generating the relevant aldehyde. Because aldehydes are a strong poison/inhibitor for the catalyst, the aldehydes must diffuse from the active site before propagation, i.e. polymerization, may occur. The two rate limiting steps, equations (1) and (2) slow catalyst initiation during initial introduction of the catalyst into the fluid bed reactor. Once the reaction product aldehyde is removed from the potential active site, the subsequent initiation reaction is believed to be rapid.

During the lag in catalyst initiation, inactive catalyst particles, and particularly catalyst fines, entrain into the cycle gas leading to fouling. Catalyst particles may then migrate to the expanded section and become precursors to expanded section sheeting. Likewise the catalyst particles may enter the bottom head leading to fouling of the distributor plate or gel formation.

To avoid the problem of catalyst initiation lag, some known methods pre-reduce the catalyst resulting in a catalyst that produces polymers having different characteristics than those produced using non-pre-reduced catalysts. Furthermore, reduced chromium oxide catalysts are sensitive to impurities and are susceptible to inactivation by the level of impurities normally found in the nitrogen stream. Finally, the pre-reduction of the catalyst is an additional process step, thereby increasing operation cost as well as process variability. To avoid these complications, catalyst reduction in the fluidized bed reactor is preferred.

In embodiments of the invention utilizing silyl chromate-based catalysts, and particularly (bis-triphenylsilyl)chromate catalyst as described herein, similar lag or initiation periods are believed to occur in the absence of the present invention.

Because concentration of ethylene in the reactor is high and the temperature elevated (generally between 100 to 115° C.), the initial reduction reaction shown in equation (1) proceeds rapidly and is not a rate limiting step in gas phase polymerization using Cr⁺⁶ -based catalysts. Rather, the subsequent diffusion step illustrated in equation (2) limits the onset of the initiation step shown in equation (3). Indeed, in the absence of the invention, onset of propagation has been observed to lag thirty minutes or more following catalyst injection into the fluidized bed.

Without being bound to any particular theory, it is believed that the present invention utilizes a catalyst initiation enhancing agent to scavenge the aldehydes created in equation (1) shown above. More particularly, the aluminum alkyl which is injected directly into the reactor in embodiments of the present invention may act as an aldehyde sponge by reaction with the aldehyde according to the following:

Al(C₂H₅)₃+ROCH→Al(C₂H₅)₂ORC₂H₆ (6)

where R═H or an alkyl group. That is the aldehyde is chemically removed from the active site of the catalyst rather than displaced by the slower diffusion process. In addition, the second and third alkyl groups of the aluminum alkyl may also react with aldehyde (particularly where R═H), thereby further facilitating the removal of aldehyde and onset of propagation. The remaining steps in the polymerization process, initiation, propagation and termination remain unchanged from conventional olefin gas phase polymerization, therefore the polymerization responses of the catalyst remain unchanged. The removal of aldehyde, however, gives rise to a higher effective initiation rate thereby increasing the effective active life residence time of the catalyst in the reactor.

In embodiments of the present invention, small quantities of a catalyst initiation enhancing agent are added to the reactor. Acceptable catalyst initiation enhancing agents are aluminum alkyls. As used herein, the term alkyl aluminum is defined as a compound having the general formula R₃Al wherein R can be any alkyl group having between two and six carbons and wherein the R groups can be the same or different. Aluminum alkyls for use as catalyst initiation enhancing agent in the present invention include by way of example and not limitation, triethylaluminum, tripropylaluminum, tri-isobutylaluminum, tri-n-butylaluminum, tri-n-hexylaluminum and tri-n-octyl aluminum. The aluminum alkyl is preferably added directly to the reactor as a dilute solution, as described hereinbelow in further detail. The solvent used to dissolve the aluminum alkyl may be the induced condensing agent (“ICA”), the comonomer, or other hydrocarbon that is not reactive with the catalyst. In preferred embodiments, the solvent is isopentane, hexane or a mixture thereof. In some preferred embodiment, the solvent used to dissolve the aluminum alkyl is the same solvent used as the ICA. In a most preferred embodiment, the solvent used to form the aluminum alkyl solution is the ICA.

In embodiments of the invention utilizing a chromium oxide based catalyst, the catalyst initiation enhancing agent is added in quantities to achieve an effective Al/Cr molar ratio in the reactor of between 0.1 to 1.0. In a preferred embodiment, the effective Al/Cr molar ratio in the reactor is between 0.2 to 0.9 and in a most preferred embodiment the effective Al/Cr molar ratio is between 0.25 to 0.7. As used herein, the term “effective Al/Cr molar ratio” means the amount of Al remaining after reaction between the aluminum alkyl and any impurities, such as water and alcohol, which may be present in the solvent used to dissolve the aluminum alkyl.

In embodiments of the invention utilizing a silyl chromate catalyst, the effective Al/Cr molar ratio may be between 0.2 and 1.5. In a preferred embodiment, the effective Al/Cr molar ratio in the reactor is between 0.4 to 1.2 and in a most preferred embodiment the effective Al/Cr molar ratio is between 0.4 to 1.0.

In addition to the effective Al/Cr molar ratio to be maintained in the reactor, the aluminum alkyl is added to the reactor in a low concentration solution. This low concentration solution may be preformed or be mixed “in-line”, for example with induced condensing agent. Generally, the concentration of the catalyst initiation enhancing agent solution, however prepared, is sufficiently low to prevent chemical reduction of the active metal in the catalyst. The aluminum alkyl is present in said solution at concentrations of less than about 0.03 molar. In a preferred embodiment the aluminum alkyl concentration in solution is less than about 0.006 molar and in a most preferred embodiment, between 0.0002 and 0.001 molar.

The resulting concentration of the aluminum alkyl in the fluidized bed reactor is between 0.003 micromoles/g and 0.01 micromoles/g of resin in the fluidized bed. In a preferred embodiment the aluminum alkyl concentration in the reactor bed is between 0.005 micromoles/g and 0.08 micromoles/g of resin in the fluidized bed.

In some embodiments of the invention, the aluminum alkyl solution is fed into the fluidized bed reactor at a location between one-eighth and three-fourths the height of the fluidized bed. In a preferred embodiment, the aluminum alkyl solution is fed into the fluidized bed reactor at a location between one-fourth and one-half the height of the fluidized bed reactor.

In an embodiment of a fluidized bed reactor, a monomer stream is passed to a polymerization section. The fluidized bed reactor may include a reaction zone in fluid communication with a velocity reduction zone. The reaction zone includes a bed of growing polymer particles, formed polymer particles and catalyst composition particles fluidized by the continuous flow of polymerizable and modifying gaseous components in the form of make-up feed and recycle fluid through the reaction zone. Preferably, the make-up feed includes polymerizable monomer, most preferably ethylene and optionally one or more cc-olefin comonomers, and may also include condensing agents as is known in the art and disclosed in, for example, U.S. Pat. No. 4,543,399, U.S. Pat. No. 5,405,922, and U.S. Pat. No. 5,462,999.

The fluidized bed has the general appearance of a dense mass of individually moving particles, preferably polyethylene particles, as created by the percolation of gas through the bed. The pressure drop through the bed is equal to or slightly greater than the weight of the bed divided by the cross-sectional area. It is thus dependent on the geometry of the reactor. To maintain a viable fluidized bed in the reaction zone, the superficial gas velocity through the bed must exceed the minimum flow required for fluidization. Preferably, the superficial gas velocity is at least two times the minimum flow velocity. Ordinarily, the superficial gas velocity does not exceed 1.5 m/sec and usually no more than 0.76 ft/sec is sufficient.

In general, the height to diameter ratio of the reaction zone can vary in the range of 2:1 to 5:1. The range, of course, can vary to larger or smaller ratios and depends upon the desired production capacity. The cross-sectional area of the velocity reduction zone is typically within the range of 2 to 3 multiplied by the cross-sectional area of the reaction zone.

The velocity reduction zone has a larger inner diameter than the reaction zone, and can be conically tapered in shape. As the name suggests, the velocity reduction zone slows the velocity of the gas due to the increased cross sectional area. This reduction in gas velocity drops the entrained particles into the bed, reducing the quantity of entrained particles that flow from the reactor. The gas exiting the overhead of the reactor is the recycle gas stream.

The recycle stream is compressed in a compressor and then passed through a heat exchange zone where heat is removed before the stream is returned to the bed. The heat exchange zone is typically a heat exchanger, which can be of the horizontal or vertical type. If desired, several heat exchangers can be employed to lower the temperature of the cycle gas stream in stages. It is also possible to locate the compressor downstream from the heat exchanger or at an intermediate point between several heat exchangers. After cooling, the recycle stream is returned to the reactor through a recycle inlet line. The cooled recycle stream absorbs the heat of reaction generated by the polymerization reaction.

Preferably, the recycle stream is returned to the reactor and to the fluidized bed through a gas distributor plate. A gas deflector is preferably installed at the inlet to the reactor to prevent contained polymer particles from settling out and agglomerating into a solid mass and to prevent liquid accumulation at the bottom of the reactor as well to facilitate easy transitions between processes that contain liquid in the cycle gas stream and those that do not and vice versa. Such deflectors are described in the U.S. Pat. No. 4,933,149 and U.S. Pat. No. 6,627,713.

The chromium-based catalyst system used in the fluidized bed is preferably stored for service in a reservoir under a blanket of a gas, which is inert to the stored material, such as nitrogen or argon. The chromium-based catalyst system is injected into the bed at a point above distributor plate. Preferably, the chromium-based catalyst system is injected at a point in the bed where good mixing with polymer particles occurs. Injecting the chromium-based catalyst system at a point above the distribution plate facilitates the operation of a fluidized bed polymerization reactor.

The monomers can be introduced into the polymerization zone in various ways including, but not limited to, direct injection through a nozzle into the bed or cycle gas line. The monomers can also be sprayed onto the top of the bed through a nozzle positioned above the bed, which may aid in eliminating some carryover of fines by the cycle gas stream.

Make-up fluid may be fed to the bed through a separate line to the reactor. The composition of the make-up stream is determined by a gas analyzer. The gas analyzer determines the composition of the recycle stream, and the composition of the make-up stream is adjusted accordingly to maintain an essentially steady state gaseous composition within the reaction zone. The gas analyzer can be a conventional gas analyzer that determines the recycle stream composition to maintain the ratios of feed stream components. Such equipment is commercially available from a wide variety of sources. The gas analyzer is typically positioned to receive gas from a sampling point located between the velocity reduction zone and heat exchanger.

The production rate of polymer composition may be conveniently controlled by adjusting the rate of catalyst composition injection, the partial pressure of ethylene in the reactor, or both. Since any change in the rate of catalyst composition injection will change the reaction rate and thus the rate at which heat is generated in the bed, the temperature of the recycle stream entering the reactor is adjusted to accommodate any change in the rate of heat generation. This ensures the maintenance of an essentially constant temperature in the bed. Complete instrumentation of both the fluidized bed and the recycle stream cooling system is, of course, useful to detect any temperature change in the bed so as to enable either the operator or a conventional automatic control system to make a suitable adjustment in the temperature of the recycle stream.

Under a given set of operating conditions, the fluidized bed is maintained at essentially a constant height by withdrawing a portion of the bed as product at the rate of formation of the particulate polymer product. Since the rate of heat generation is directly related to the rate of product formation, a measurement of the temperature rise of the fluid across the reactor, i.e. the difference between inlet fluid temperature and exit fluid temperature, is indicative of the rate of inventive polyethylene composition formation at a constant fluid velocity if no or negligible vaporizable liquid is present in the inlet fluid.

On discharge of particulate polymer product from reactor, it is desirable and preferable to separate fluid from the product and to return the fluid to the recycle line. There are numerous ways known to the art to accomplish this separation. Product discharge systems which may be alternatively employed are disclosed and claimed in U.S. Pat. No. 4,621,952, U.S. Pat. No. 6,255,411 and U.S. Pat. No. 6,498,220 Such a system typically employs at least one (parallel) pair of tanks comprising a settling tank and a transfer tank arranged in series and having the separated gas phase returned from the top of the settling tank to a point in the reactor near the top of the fluidized bed.

In the fluidized bed gas phase reactor embodiment, the reactor temperature of the fluidized bed process herein ranges from 70° C. or 75° C., or 80° C. to 90° C. or 95° C. or 100° C. or 110° C. or 115° C. , wherein a desirable temperature range comprises any upper temperature limit combined with any lower temperature limit described herein. In general, the reactor temperature is operated at the highest temperature that is feasible, taking into account the sintering temperature of the inventive polyethylene composition within the reactor and fouling that may occur in the reactor or recycle line(s).

The process of the present invention is suitable for the production of homopolymers comprising ethylene derived units, or copolymers comprising ethylene derived units and at least one or more other α-olefin(s) derived units.

In order to maintain an adequate catalyst productivity in the present invention, it is preferable that the ethylene is present in the reactor at a partial pressure at or greater than 160 psia (1100 kPa), or 190 psia (1300 kPa), or 200 psia (1380 kPa), or 210 psia (1450 kPa), or 220 psia (1515 kPa) to as high as 250 psia.

The comonomer, e.g. one or more α-olefin comonomers, if present in the polymerization reactor, is present at any level that will achieve the desired weight percent incorporation of the comonomer into the finished polyethylene. This is expressed as a mole ratio of comonomer to ethylene as described herein, which is the ratio of the gas concentration of comonomer moles in the cycle gas to the gas concentration of ethylene moles in the cycle gas. In one embodiment of the inventive polyethylene composition production, the comonomer is present with ethylene in the cycle gas in a mole ratio range of from 0 to 0.1 (comonomer:ethylene); and from 0 to 0.05 in another embodiment; and from 0 to 0.04 in another embodiment; and from 0 to 0.03 in another embodiment; and from 0 to 0.02 in another embodiment.

Hydrogen gas may also be added to the polymerization reactor(s) to control the final properties (e.g., I₂₁ and/or I₂) of the polyethylene polymer composition. In one embodiment, the ratio of hydrogen to total ethylene monomer (ppm H₂ / mol % C₂) in the circulating gas stream is in a range of from 0 to 60:1 in one embodiment; from 0.10:1 (0.10) to 50:1 (50) in another embodiment; from 0 to 35:1 (35) in another embodiment; from 0 to 25:1 (25) in another embodiment; from 7:1 (7) to 22:1 (22).

Finally, oxygen may be added to the reactor in extremely small amounts to control polymer molecular weight. Addition of oxygen to the reactor results in a decrease in the average molecular weight of the polymer. Since the other primary control of molecular weight in these Cr⁺⁶ catalyst systems is reaction temperature, oxygen addition allows production of lower molecular weight products at reduced operating temperatures. This can be of value when operating in condensing mode as well as allowing production of resins that might otherwise not be within an operable temperature range.

Oxygen functions as a chain terminator and also as a catalyst deactivator, i.e. the chain termination, unlike that depicted in equation (5), does not result in a terminated polymer chain with a regenerated active site. Without being bound by any particular theory, it is believed that the oxygen permanently converts the active site to a “dead” site, possibly through formation of a chromium oxide that is not reducible by ethylene or aluminum alkyl.

Typical oxygen addition levels are in the range of between 10 to 300 parts per billion of ethylene fed to the reactor. The amount of oxygen is generally determined as the amount needed to obtain the desired reduction in molecular weight without reducing catalyst productivity to an unsuitable level. In a typical use of oxygen addition, the reaction conditions will be adjusted to produce resin of a desired molecular weight and density and then oxygen addition is used to fine tune the resin molecular weight.

### EXAMPLES

The following examples illustrate the present invention but are not intended to limit the scope of the invention. While the following examples were not conducted at sufficiently high rates to result in condensed mode operation, they are exemplary of the effect of the invention. Likewise, the following comparative examples were not operated in a condensed mode but illustrate the differences observed in the absence of the invention.

### Example 1

Ethylene/1-hexene copolymers were produced in accordance with the following general procedure. The catalyst composition comprised a silica-supported(bis-triphenylsilyl)chromate that had been pre-contacted with diethylaluminum ethoxide and an Al/Cr ratio of 1.5. This catalyst is UCAT™ UG-150 and is available form Univation Technologies LLC. Catalyst preparation was performed as described in U.S. Pat. No. 7,202,313, which is incorporated herein in its entirety by reference. The catalyst composition was injected into a fluidized bed gas phase polymerization reactor using a nitrogen carrier. Fluidizing gas was passed through the bed at a velocity of 0.49 to 0.762 m per second. The fluidizing gas exiting the bed entered a resin disengaging zone located at the upper portion of the reactor. The fluidizing gas then entered a recycle loop and passed through a cycle gas compressor and water-cooled heat exchanger. The shell side water temperature was adjusted to maintain the reaction temperature to the specified value. Ethylene, hydrogen, 1-hexene and nitrogen were fed to the cycle gas loop just upstream of the compressor at quantities sufficient to maintain the desired gas concentrations. Gas concentrations were measured by an online vapor fraction analyzer. Polymer product was withdrawn from the reactor in batch mode into a purging vessel before it was transferred into a product bin. The reactor did not enter condensed mode operation. The catalyst initiation enhancing agent was triethylaluminum dissolved in hexane. Table I summarizes the reaction conditions and polymer properties resulting from Example 1 and Comparative Example 1 described hereinafter.

### Comparative Example 1

Ethylene/1-hexene copolymers were produced in accordance with the procedure discussed in connection with Example 1 except that no catalyst initiation enhancing agent was utilized.

TABLE 1

| | EX. 1 | COMPARATIVE EX. 1 |
|---|---|---|
| REACTION CONDITIONS | | |
| Temp., ° C. | 90.8 | 92.5 |
| C₂ partial pressure, psi | 249.5 | 2509.0 |
| H₂/C₂ molar ratio | 0.0500 | 0.0503 |
| C₆/C₂ molar ratio | 0.0070 | 0.0091 |
| Alkyl type | 0.025% TEAL | NONE |
| Alkyl feed, cc/hr | 49.8 | 0.0 |
| Production rate lb/hr | 34.1 | 32.7 |
| POLYMER PROPERTIES | | |
| Flow index I₂₁, dg/min | 5.55 | 7.44 |
| Ext. FI | 5.16 | 8.20 |
| I₅ | 0.197 | 0.285 |
| Density, g/cm³ | 0.9440 | 0.9441 |
| MFR FI/I₅ | 28.2 | 26.14 |
| Chromium ppmw | 0.6909 | 0.8164 |
| Al/Cr | 0.4035 | None |
| Productivity, lb/lb of catalyst | 3618 | 3062 |
| Bulk density, lb/ft³ | 33.9 | 33.3 |
| APS, inches | 0.028 | 0.027 |
| Fines, wt% LT120 mesh | 0.7 | 1.0 |

### Example 2 And Comparative Example 2

Example 2 illustrates the ability of the invention to prevent operational problems, and more particularly, reactor sheeting. Ethylene/1-hexene copolymers were produced in accordance with the general procedure of Example 1 except for the following specific conditions. The catalyst composition was a Cr⁺⁶ oxide supported on silica gel that had been previously treated with a titanate compound as described in U.S. Pat. No. 7,202,313, with the following differences. The silica support was Crosfield EP-30X and the titanated chromium on silica was first heated to 600° C. in nitrogen before switching over to an air atmosphere. Final temperature was 825° C. Following about twelve hours of operation the aluminum alkyl feed, triethylaluminum dissolved in hexane as in Example 1, was decreased as shown in Table 2. Comparative Example 2 data was then obtained and exhibited reactor sheeting with required shutdown within twenty-four hours of decreasing the aluminum alkyl feed.

TABLE 2

| | Ex. 2 | Comparative Ex. 2 |
|---|---|---|
| REACTION CONDITIONS | | |
| Chromium ppmw | 0.5100 | 0.5100 |
| Al/Cr | 0.4858 | 0.2581 |
| TEAL/g | 0.00477 | 0.00254 |
| Reactor operation | Smooth | Sheeted within 24 hours |
| POLYMER PROPERTIES | | |
| Bulk Density, lb/ft³ | 26.9 | 27.1 |
| APS, inches | 0.026 | 0.026 |

### Example 3 And Comparative Example 3

Ethylene/1-hexene copolymers were produced in accordance with the following general procedure. The catalyst composition comprised chromium oxide supported on silica dissolved in hexane. The catalyst composition was injected into a fluidized bed gas phase polymerization reactor. Fluidizing gas was passed through the bed at a velocity between 0.49 and 0.762 m per second. The fluidizing gas exiting the bed entered a resin disengaging zone located at the upper portion of the reactor. The fluidizing gas then entered a recycle loop and passed through a cycle gas compressor and water-cooled heat exchanger. The shell side water temperature was adjusted to maintain the reaction temperature to the specified value. Ethylene, hydrogen, 1-hexene and nitrogen were fed to the cycle gas loop just upstream of the compressor at quantities sufficient to maintain the desired gas concentrations. Gas concentrations were measured by an online vapor fraction analyzer. Polymer product was withdrawn from the reactor in batch mode into a purging vessel before it was transferred into a product bin. The reactor did not enter condensed mode operation. The catalyst initiation enhancing agent was triethylaluminum dissolved in hexane. Following about twelve hours of operation, the aluminum alkyl feed was discontinued and data for Comparative Example 3 obtained. Following discontinuation of aluminum alkyl feed, reactor sheeting and gel formation were observed within twenty hours. In addition, the amount of fines detected in the produced polymer (and therefore entrained in the process) are greater in Comparative Example 3 in comparison to Example 3. Likewise, the bulk density of the polymer produced is lower in Comparative Example 3 in comparison to Example 3. Table 3 summarizes the reaction conditions and polymer properties resulting from Example 3 and Comparative Example 3.

TABLE 3

| | Ex. 3. | Comparative Ex. 3 |
|---|---|---|
| REACTOR CONDITIONS | | |
| Cr wt % | 0.214 | 0.214 |
| Temp., ° C. | 108 | 108 |
| Inlet Temp., ° C. | 100.9 | 100.9 |
| Pressure, psig | 348 | 348 |
| C₂ partial pressure, psi | 224.6 | 224.8 |
| H₂/C₂ molar ratio | 0.0500 | 0.0500 |
| C₆/C₂ molar ratio | 0.0015 | 0.0015 |
| 0₂/C₂ | 0.080 | 0.080 |
| E.B. production rate, lb/hr | 31.668 | 30.683 |
| aluminum alkyl type | 0.025% TEAL | None |
| aluminum alkyl feed cc/hr | 46.9 | 0.0 |
| MB production rate lb/hr | 31.1 | 27.7 |
| Residence time, hr. | 1.86 | 1.96 |
| SGV (ft/sec) | 1.5 | 1.5 |
| RESIN PROPERTIES | | |
| Flow index, I₅ | 32.96 | 58.32 |
| I₅ | 1.917 | 3.964 |
| I₂ | 0.424 | 0.995 |
| Density, g/cm3 | 0.9515 | 0.9524 |
| MFR | 77.6978 | 58.6196 |
| MFR FI/I₅ | 17.2 | 14.7 |
| Chromium ppm | 0.4624 | 0.4852 |
| Al/Cr | 0.5219 | 0.0000 |
| Productivity, lb/hr | 4628 | 4410 |
| Bulk density, lb/ft³ | 23.9 | 23.0 |
| APS, inches | 0.026 | 0.028 |
| Fines, wt % LT120 mesh | 2.3 | 3.2 |
| TEAL/O₂ | 0.89 | 0.00 |
| TEAL, micromoles/g | 0.0046 | 0.0000 |

Increased amounts of static in the reactor were also observed, presaging reactor fouling.

### TEST METHODS

Test methods include the following: Density (g/cm³) was measured according to ASTM-D 792-03, Method B, in isopropanol. Specimens were measured within 1 hour of molding after conditioning in the isopropanol bath at 23° C. for 8 min to achieve thermal equilibrium prior to measurement. The specimens were compression molded according to ASTM D-4703-00 Annex A with a 5 min initial heating period at about 190° C. and a 15° C./min cooling rate per Procedure C. The specimen was cooled to 45° C. in the press with continued cooling until “cool to the touch.”

Melt index (I₂) was measured at 190° C. under a load of 2.16 kg according to ASTM D-1238-03.

Melt index (I₅) was measured at 190° C. under a load of 5.0 kg according to ASTM D-1238-03.

Melt index (I₁₀) was measured at 190° C. under a load of 10.0 kg according to ASTM D-1238-03.

Melt index (I₂₁) was measured at 190° C. under a load of 21.6 kg according to ASTM D1238-03.

The present invention may be embodied in other forms without departing from the spirit and the essential attributes thereof, and, accordingly, reference should be made to the appended claims, rather than to the foregoing specification, as indicating the scope of the invention.

We claim:

1. A gas phase polymerization process for producing a polyethylene polymer comprising the step of:
polymerizing ethylene and optionally at least one α-olefin comonomer in a fluidized bed reactor under condensed mode operating conditions using a Cr⁺⁶-based supported catalyst and a catalyst initiation enhancing agent comprising an aluminum alkyl.

2. The gas phase polymerization process for producing a polyethylene polymer according to claim 1, wherein the aluminum alkyl is selected from the group consisting of compound having the general formula R₃Al wherein R can be any alkyl group having between two and six carbons and wherein the R groups can be the same or different.

3. The gas phase polymerization process for producing a polyethylene polymer according to claim 1, wherein the aluminum alkyl is selected from the group consisting of triethylaluminum, tripropylaluminum, tri-isobutylaluminum, tri-n-butylaluminum, tri-n-hexylaluminum and tri-n-octyl aluminum.

4. The gas phase polymerization process for producing a polyethylene polymer according to claim 1, wherein the aluminum alkyl is dissolved in a solvent selected from the group consisting of induced condensing agents, the at least one comonomer, and a hydrocarbon that is unreactive with the Cr⁺⁶-based supported catalyst to form an aluminum alkyl solution.

5. The gas phase polymerization process for producing a polyethylene polymer according to claim 4, wherein the concentration of aluminum alkyl in the solvent is less than about 0.03 molar.

6. The gas phase polymerization process for producing a polyethylene polymer according to claim 1, wherein the aluminum alkyl solution is injected into the fluidized bed reactor at a location between about one-eighth and three-fourths the height of the fluidized bed.

7. The gas phase polymerization process for producing a polyethylene polymer according to claim 1, wherein the concentration of the aluminum alkyl in the fluidized bed reactor is between 0.003 and 0.010 micromoles/g of resin in the fluidized bed.

8. The gas phase polymerization process for producing a polyethylene polymer according to claim 1, wherein the catalyst is selected from the group consisting of a chromium oxide, a chromium compound oxidizable to Cr⁺⁶, and a chromate ester.

9. The gas phase polymerization process for producing a polyethylene polymer according to claim 8, wherein the catalyst is (bis-triphenylsilyl)chromate or diethylaluminumethoxide.

10. The gas phase polymerization process for producing a polyethylene polymer according to claim 8, wherein the catalyst is supported on a refractory oxide, other inorganic oxide granular or microspherical support.

11. The gas phase polymerization process for producing a polyethylene polymer according to claim 10, wherein the catalyst is supported on silica, silica-alumina, thoria, or zirconia.

12. The gas phase polymerization process for producing a polyethylene polymer according to claim 8, wherein the fluidized bed has an effective Al/Cr molar ratio of between 0.2 and 1.5.

13. The gas phase polymerization process for producing a polyethylene polymer according to claim 1 further comprising injecting oxygen into the reactor to control polymer molecular weight.

14. A polyethylene polymer produced via the gas phase polymerization process of claim 1.

15. A catalyst initiation enhancing system for use in a fluidized bed polymerization reactor operating in condensed mode comprising:
at least one aluminum alkyl;
at least one hydrocarbon solvent,
wherein the aluminum alkyl is present in the solvent at concentrations of less than about 0.03 molar.
